(19) United States
(12) Patent Application Publication
(10) Pub. No.: US 2025/0132636 A1
(43) Pub. Date: Apr. 24, 2025

(54) EXCITER LUBRICATION SYSTEM

(71) Applicant: SANDVIK ROCK PROCESSING AUSTRALIA PTY LIMITED, New South Wales (AU)

(72) Inventors: Andreas WIELTSCH, New South Wales (AU); Simon MANN, New South Wales (AU)

(21) Appl. No.: 18/694,403

(22) PCT Filed: Sep. 21, 2022
(86) PCT No.: PCT/AU2022/051138

§ 371 Date: Mar. 21, 2024

(30) Foreign Application Priority Data
Sep. 22, 2021 (AU) 2021903046

(51) Int. Cl. H02K 7/06; F16C 33/66; F16H 57/02; F16H 57/021; F16H 57/04; H02K 7/08; H02K 7/116

(52) U.S. Cl. CPC H02K 7/061; F16C 33/6659; F16H 57/021; F16H 57/0404; F16H 57/0449; F16H 57/045; F16H 57/0457; F16H 57/0471; F16H 57/0495; H02K 7/08; H02K 7/116; F16H 2057/02073

(57) ABSTRACT

A vibration exciter apparatus includes an exciter housing, and two bearing means, each supporting a driven shaft carrying eccentric mass means. The driven shafts carrying intermeshing gears. The exciter housing having an array of bore passages extending from an upper wall to a lower wall of the exciter housing, and a mounting structure plate securable to mineral processing or handling equipment intended to be vibrated by the exciter apparatus. Each of the bearing means and the intermeshing gears having separated lubrication liquid sumps. The exciter housing further having the mounting structure plate with an array of fastener receiving zones, whereby elongated fastener means can pass through the bore passages from the upper wall to be engaged in the fastener receiving zones.

### FIELD OF THE INVENTION

This disclosure relates to exciter apparatus and parts thereof, the exciter apparatus, either alone or in combination with other similar devices, being intended to impose a vibration regime to mineral processing or handling equipment during use of such equipment. While mineral processing or handling applications such as mining ore, coal and quarrying activities are relevant, other comparable applications are possible and are also applicable to this development.

### BACKGROUND OF THE INVENTION

Exciter apparatus for imposing a vibration regime to mineral processing or handling equipment of various designs and configurations are known. One such apparatus is a series of exciters identified by reference serial numbers DF6xx provided by “Schenck Process”. Similar exciter apparatus is also provided by various other entities. Typical features of DF6xx series exciter apparatus are illustrated in FIGS. 1 to 4 annexed hereto and are described in greater detail in the following text. The prior art vibration exciter apparatus 10 includes a cast exciter housing 11 with opposed side walls 12, 13, opposed end walls 14, 15, and a closed base wall. The upper face of the cast exciter housing 11 is substantially open with a surrounding seal flange 16, the upper face being closed when assembled by a top wall plate 17, a seal gasket 18 and a plurality of fasteners 19. Each of the side walls 12, 13 have adjacent openings 20, 21 to allow a long driven shaft 22 and a short driven shaft 23 to project there through in the assembled structure (FIG. 1). In this assembled structure, the outer ends of the shafts 22, 23 carry eccentric masses 24 with the arrangement of the masses 24 being overlapping as shown in FIG. 1. Each of the openings 20, 21 in the side walls 12, 13 are closed in the assembled structure (FIG. 1) by closure plates 25, 26 that are sealed to the side walls 12, 13 and include seals that seal on the driven shafts 22, 23. The driven shafts 22, 23 are carried by bearings 27 which typically are a pair of spherical roller bearings (SRB) positioned on each shaft 22, 23. As shown in FIG. 4, a pair of intermeshing gears 28 are mounted on each driven shaft 22, 23 where the intermeshing gears 28 are axially positioned between the bearings 27 on each driven shaft 22 or 23. The interior of the exciter housing 11, in its lower regions, provides a liquid lubricant zone or sump 29 with the liquid lubricant being introduced through an upper inlet opening 30 and drained through a lower drain opening 31 when required. When in use, the inlet opening 30 and lower drain opening 31 are closed by removable plugs or stopper members. Each of the four bearings 27 and the intermeshing gears 28 are intended to be splash lubricated from the lubricant in the common sump 29.

The exciter housing 11 has a lower outwardly extending flange 32 with a plurality of fastener (bolt) receiving bores 33 along their lengths to allow fastener bolts or the like to secure the exciter apparatus 10 to the desired position on processing or handling equipment, typically mineral processing or handling equipment. The outwardly extending flanges 32 may be strengthened or stiffened by vertical webs 34, however, such webs tend to make it difficult to rotate the fastener bolts (or similar) when installing or removing the exciter apparatus.

The driven shafts 22, 23, in use, are drivingly connected to a drive motor or motors to rotate the eccentric masses 24 to create the desired vibration regime. Various arrangements for achieving this are known including, but not limited to, a drive motor driving each shaft, a drive motor driving one shaft with rotation being drivingly transferred to the other shaft by gearing means including the inter meshing gears shown in FIG. 4. Exciter apparatus utilising one driven shaft or more than two driven shafts are known and some aspects of the developments disclosed in the following specification will be recognised as applying to such exciter apparatus. Drive arrangements for the driven shaft are known and therefore are not further shown or described in the following.

Several other published prior art references are briefly discussed in the following. Chinese patent specification no CN112610871A has a housing constructed similarly to that described above in relation to the DF6xx series exciter housing except that the bearings supporting the driven shafts are not lubricated by splash lubrication from a sump containing liquid lubricant but rather by a pump and delivery passages delivering liquid lubricant to the bearings, presumably to try to improve bearing lubrication. The specification discloses intermeshing gears, only one of which is drivingly carried by one of the driven shafts with the other directly driving the aforesaid pump. Intermeshing gears carried by both driven shafts are not shown. Australian Patent Specification No 2014201607A1 discloses exciter apparatus having a casing or housing similarly constructed to the above described DF6xx series exciter apparatus except that it positively defines that no intermeshing gearing mounted from the driven shafts are shown or intended to be used. The internal space of the housing does have two separate liquid lubricant sump zones for the respective shaft bearings formed by an intermediary wall.

The above discussed DF6xx series exciter apparatus 10 and similar exciter apparatus from other sources are generally fixed to the processing or handling apparatus intended to be vibrated by using relatively standard fasteners at a base level of the exciter apparatus. Generally, the fasteners are relatively short passing through a flange at the base of the exciter apparatus. They are subjected to high dynamic loads and are susceptible to breakage when tightening has not been completed correctly. The arrangement of these connection fasteners at a base level of the exciter apparatus often requires the eccentric masses to be rotated and supported and installation or removal personnel to get underneath the exciter apparatus to tighten or loosen the multiple fastener bolts. This is not a particularly ergonomic task and can also be a hazardous operation. A still further issue with the configuration of current designs of exciter apparatus is that a completely different and complex exciter apparatus casing needs to be produced each time the connection pattern of fastener bolts changes. More particularly, if replacement exciter apparatus is to be used on processing or handling equipment constructed for some other exciter apparatus design, then either the complete exciter housing has to be redesigned or the processing or handling equipment has to be modified. In known exciter apparatus it is also reasonably common to utilise alignment pins or the like to try to ensure the exciter apparatus is correctly positioned or aligned. Such means are often not used, or not correctly used, during installation on site. Multiple designs result in higher supply costs.

Furthermore, in the above discussed existing design arrangements, it is commonplace to provide dynamic guard shields protectively encasing the eccentric masses 24 carried by the driven shafts 22, 23. Such dynamic guard shields are generally mounted to the exciter casing or parts thereof by multiple fastener elements, the guard shields generally obstructing access to the fasteners securing the exciter casing to the processing or handling equipment. Thus, if the exciter apparatus is to be removed, for any reason, generally the dynamic guard shields will also need to be removed, which is a reasonably time consuming task.

Furthermore, the above discussed vibration exciters and similarly constructed exciters utilising intermeshing gears are typically mounted to mineral processing or handling equipment such as vibrating screening apparatus for separating mined ore material into sized particle ranges and feeders therefore in a variety of positions and angles of inclination including at least partially inverted positions. These exciters typically use a splash lubrication system where a single lubricating liquid bath is provided in a single sump contained within the exciter housing with the lower gear, given the orientation of the exciter housing, engages the lubricating liquid and splashes same onto the various moving parts including the bearings and the other intermeshing gear. There is, however, believed to be some shortcomings with this existing arrangement. Specifically, at start up, and with some viscosity characteristics of the lubricating liquid, there may not be sufficient lubricating liquid getting operationally to the bearings and particularly the bearing(s) located furthest from the liquid lubricant bath. It may, for example, be desirable to have different lubricating characteristics for the bearings compared to the gears, particularly at start up, but this is not possible with a single sump exciter housing that must provide the same lubricating liquid for the bearings and the gears. Still further, moving parts within such vibration exciter apparatus create wear particles that increasingly adversely affects the moving parts. It is believed that such wear particles are more likely to be generated by intermeshing gears rather than bearing structures, however, in a single sump housing structure it is impossible to isolate wear particles originating from the intermeshing gears from the bearings. Moreover, liquid lubricant degradation occurs when elevated temperatures are experienced during operation of the vibration exciter apparatus.

Current DF6xx series exciter apparatus from Schenck Process and other similar apparatus rely exclusively on natural convective cooling from external surfaces of the exciter apparatus. This results in relatively high operating temperatures, particularly around the bearings. These high temperatures result in the condition of the liquid lubricant deteriorating relatively quickly. The high temperatures also limit the life of elastomeric seals such as lip or V-ring seals. Current exciter apparatus commonly utilise felt seals, particularly to seal rotating shafts, however these seal types are not fully airtight and may allow leakage or ingress of damaging debris particles or water which can accumulate over time. Generally it would be desirable to use elastomeric sealing members but to do so, operating temperatures need to be significantly reduced. In this regard, relying on current convective cooling effects would not be sufficient.

Exciter apparatus normally operate in relatively harsh environments and while the internal zones are sealed, at least to some extent, it is possible for small amounts of externally originating particle debris or water to enter the internal spaces. Moreover, the harsh operating characteristics of exciter apparatus does cause metal wear particles to be formed over a period of use which also collect in internal zones. Such particle material can have significant adverse life effects on the internal moving parts and particularly the bearings. Exciter apparatus of the aforedescribed type have generally become larger over time producing higher magnitudes of force, and as a result, they tend to run hotter due to higher friction associated with larger bearings being used. This circumstance provides significant complications for selecting a lubricating liquid with a suitable viscosity characteristic, that is, low enough at start up but high enough to provide adequate lubrication and resistance against contaminants during normal or continuous operation. Moreover, if during a maintenance stage, lubricating liquid is introduced with incorrect lubricating characteristics, then this can have a significant adverse effect on operational life. Further, known vibration exciter apparatus either have no live (that is, during operation) method of sensing lubrication liquid levels in lubricating liquid sumps, or have basic lubricating liquid level sensing methods such as the use of dipsticks that are operational only when the vibration exciter apparatus is not in operational use. Still further, such liquid level sensing methods that do exist, can be affected by issues associated with installation configurations of such vibration exciter apparatus.

Some of the foregoing factors and others have resulted in exciter apparatus, particularly those used in harsh environments such as mine sites and the like, to ideally require relatively short period maintenance operations to be carried out on site by available site based maintenance personnel. At the same time, mine operators have been moving away from employing site-based maintenance employees for carrying out such maintenance operations. Moreover, regular relatively short period onsite maintenance operations tend to provide unwanted and non-productive shutdown, or at least partial shutdown of potentially high income earning activities which is generally not desired. It is therefore recognised that longer periods between requiring any maintenance activities would be desirable, and particularly, it would be desirable to have a bolt in, bolt out replacement process whereby maintenance and/or renovation of such exciter apparatus might occur offsite by personnel experienced in such specialised activities.

### BRIEF SUMMARY OF THE INVENTION

An objective of the present development is to provide improvements in vibration exciter apparatus, or in lubrication of moving parts of such vibration exciter apparatus and preferably also parts thereof, that will enable an improvement in periods between which regular maintenance activities might be carried out. A further preferred objective is to provide improvements in the design of exciter apparatus, or in parts thereof, that will allow ease of installation, or removal of exciter apparatus from processing or handling equipment requiring vibration during use. The latter objective being to also assist with maintenance activities when required, and to provide a possibility of providing a bolt in, bolt out, replacement process, if an external offsite renovation/maintenance program is to be followed. A still further preferred objective is to provide improvements in vibration exciter apparatus that will enable a standard vibration exciter design to be installed on processing or handling equipment in a variety of differing installation orientations without substantially affecting performance of the vibration exciter apparatus, in use.

According to a first aspect of this development, a vibration exciter apparatus is provided configured, in use, to impose a vibration regime to vibration processing or handling equipment, said exciter apparatus including an exciter housing, first bearing means and second bearing means positioned in said exciter housing each supporting a driven shaft carrying eccentric mass means externally of said exciter housing, a pair of intermeshing gears, each being carried by a said driven shaft for rotation therewith, a first liquid lubricant sump for a first one of said bearing means located within said exciter housing, a second liquid lubricant sump for a second one of said bearing means located within said exciter housing whereby said second liquid lubricant sump is separate from said first liquid lubricant sump, and a third liquid lubricant sump for said intermeshing gears located within said exciter housing, said third liquid lubricant sump being separate from said first and said second liquid lubricant sumps.

Conveniently, in use, the first one of said bearing means is partially immersed in liquid lubricant located in said first liquid lubricant sump and said second one of said bearing means is partially immersed in liquid lubricant located in said second liquid lubricant sump. Preferably, in use, at least one of said intermeshing gears is partially immersed in liquid lubricant in said third liquid lubricant sump.

Providing bath lubrication from sump pools is the simplest method of lubrication of moving parts in vibration exciter apparatus and providing separate pools or sump regions for the main moving parts allows separate liquid lubricants to be used for respective moving parts, if considered as desirable, as well as providing better control and maintenance of liquid lubricant to each of the main moving parts. Significant advantages are also achieved utilizing intermeshing gears in the vibration exciter apparatus. More particularly, providing a separated and isolated sump zone for the intermeshing gears retains any wear particle debris in this zone, thereby minimising or preventing distribution of same into the region of the bearings.

In a preferred arrangement, the first one of said bearing means comprises at least two bearing members, one said bearing member being a spherical roller bearing and a second one of said bearing members being a toroidal roller bearing member.

Preferably, an interior region of the exciter housing is divided by an intermediary wall portion into two compartment zones, one of said two compartment zones mounting the first one of said bearing means, and a second one of said two compartment zones mounting the second one of said bearing means, each of said two compartment zones being positioned adjacent a first side face of said exciter housing. The interior region of said exciter housing includes a third compartment zone housing said intermeshing gears, said third compartment zone being positioned between said two compartment zones and a second side face of said exciter housing opposite said first side face of said exciter housing. Preferably, the exciter housing may include an exciter casing with an upper wall, a lower wall, and two opposed end walls connected to said upper and said lower walls, at least said second side face of said exciter casing is substantially open being closable by a first side wall securable to the upper wall, the lower wall and said end walls by a plurality of first fastener elements. The first side face of said exciter casing is substantially open and is closable by a second side wall securable to the upper wall, the lower wall and said end walls by a plurality of second fastener elements. Conveniently, the exciter casing has an intermediary open region between said two compartment zones and said third compartment zone, an intermediary dividing wall being securable to said exciter casing to separate said third compartment zone from said two compartment zones.

Each of the first liquid lubricant sump, the second liquid lubricant sump and/or the third liquid lubricant sump may have the following features as aspects associated therewith. Firstly, they may each have liquid lubricant inlet means that may allow liquid lubricant to be introduced into the respective sump when required. Such inlet means may include removable or openable closure elements that can be reapplied once the liquid lubricant has been introduced. Secondly, each of the sumps may also have drain means allowing, when required, drainage of liquid lubricant from the respective sumps. The or each of the drain means might also include removable or openable closure elements to open or reclose the drain means. Still further, each of the sumps may include an enlarged particulate debris collection or settling zone immediately adjacent the or each drain means such that any particulate debris might collect therein without having it return to an active or operational zone of the sump. Trap means might be provided around the enlarged collection or settling zones to allow particulate debris to move into the collection zone while inhibiting movement of same back into the active operational zones of each sump. Alternatively, such trap means might also include magnetic attraction element(s) to attract and hold ferro based particle material, either as separate means or in addition to the trap means just described. The magnetic attraction element(s) may be electro magnetic in nature whereby the magnetic attraction capability can be turned off when it is desired to flush particulate debris material out of a particular liquid lubricant sump. Fourthly, each of the sumps might include a liquid lubricant level sensor positioned to sense and report liquid lubricant level in the respective sump.

In a particularly preferred embodiment, the exciter housing may include at least one, and preferably multiple, fastener receivable passage means extending from said upper wall to said lower wall through at least each said end wall, and through an intermediary part of said exciter housing between said first and said second liquid lubricant sumps. Preferably, the aforesaid mounting arrangement permits selectably, either said upper wall or said lower wall to be positioned closer to the vibration processing or handling equipment when said vibration exciter apparatus is mounted thereto.

In another preferred aspect of this development, a vibration exciter apparatus casing is provided for use in vibration exciter apparatus intended, in use, to impose a vibration regime to vibration processing or handling equipment, said vibration exciter apparatus casing having a substantially continuous wall structure with an upper wall portion, an opposed lower wall portion, two mutually spaced and opposed end wall portions, and two mutually spaced side faces together defining an internal zone, said internal zone including two bearing mounting compartments separated by a transversely disposed intermediate wall structure extending from a first said side face, each said bearing mounting compartment including a bearing lubricating liquid sump zone separate from the other said bearing mounting compartment, said transversely disposed intermediate wall structure and said bearing mounting compartments being spaced from a second said side face opposed to said first side face whereby a gearing mounting compartment and an associated gearing lubricating liquid sump zone are positioned adjacent said second side face.

Preferably, at least one fastener receivable bore passage passes through each said end wall portion and said intermediate wall structure from said upper wall portion to said lower wall portion. Conveniently, at least two said fastener receivable bore passages are provided through each said end wall portion. Preferably at least two said fastener receivable bore passages are provided through said intermediate wall passage.

Conveniently, a first end zone and a second end zone of each of the aforesaid fastener receivable passage means include engagement formation means cooperable with a fastener receiving fitting means whereby, when engaged, movement in a lateral direction is inhibited or prevented. In one preferred arrangement, the fastener receivable passage means are arranged in an array wherein said fastener receivable passage means at one end is a mirror image of said fastener receiving bore means at an opposed end located about a central transverse axis. Preferably, the aforementioned arrangement allows the liquid lubricant in bearing lubricant liquid sump zone(s) to be maintained essentially in the same position, or on the same side of the driven shaft supported by the bearing means, irrespective of the mounting orientation of the exciter apparatus housing. The benefits arising out of this ability are:
there is one set of drain points which can always be utilised and will fully drain the sump zone(s) as incomplete draining of the sump zone(s) will leave contaminants;
particulate (debris) capture devices can be located in one place only and can always be submerged in the liquid lubricant, that is, a limitation of the number of such capture devices is achievable; and
the lubricant liquid level within the bearing sump zone(s) remains the same with respect to the distance from the driven shaft axis (or axes), irrespective of mounting orientation/angle. That is, lubricant liquid can be filled in the factory manufacture stage and does not need to be adjusted for different installation angles/orientations.

A still further advantage of the disclosed mounting arrangements is that the eccentric masses do not need to be rotated to the opposite side of the exciter apparatus in underslung orientations installation, thereby avoiding health and safety risks to the installing personnel.

In yet another preferred aspect, exciter apparatus may be provided configured, in use, to impose a vibration regime to processing or handling equipment, said exciter apparatus including an exciter housing, first bearing means and second bearing means positioned in said exciter housing, supporting two spaced driven shafts each carrying eccentric mass means externally of said exciter housing, said first and said second bearing means being lubricated by lubrication from individual lubrication liquid sumps for each of said first and said second bearing means, said exciter apparatus including cooling means to cool said first and said second bearing means and/or lubrication liquid in said individual lubrication liquid sumps. The cooling means may include a heat transfer assembly or device to move heat from an internal heat generating region of said vibration exciter apparatus to a position external of said exciter housing. Preferably, the cooling means may include the use of one or more heat pipes configured as described in the following parts of this specification. The term “heat pipe” is used in this specification to denote a heat transport system typically comprising a pipe constructed from a heat conductive metal such as copper that is closed at both ends to provide a closed system and contains a wick structure (e.g. powdered sintered copper) together with a liquid (including water) that is capable of absorbing heat to evaporate and condense again when it has moved to a cooler zone of the heat pipe. The evaporating and condensing of the liquid produce a form of pumping action or recirculation of the liquid/vapors in the heat pipe to cause movement along the heat pipe and thereby move heat from one end of the heat pipe to the other end of the heat pipe. Heat pipes do not, in themselves, dissipate heat but rather absorb heat at one end and lose heat at the other end if it is located in a cooler zone.

Preferably the cooling means may include one or more of the foregoing:
(i) a heat pipe or multiple heat pipes in an assembly, or multiple such assemblies, positioned in axially extending bores or passages, in the driven shaft(s);
(ii) one or more heat pipe(s) or assemblies of heat pipe(s) positioned in passage(s) in a wall structure or structures of the vibration exciter housing adjacent a liquid lubricant sump zone;
(iii) heat conductor elements embedded in one or each driven shaft;
(iv) heat conductor elements embedded in wall structures of the exciter housing adjacent one or more of the liquid lubricant sump zones(s);
(v) heat flow passages in one or both of the driven shafts to permit passage of a cooling fluid/gas there through;
(vi) heat flow passages in wall structures adjacent one or more of the liquid lubricant sump zones to allow a cooling fluid/gas flow there through; and
(vii) cooling from fan means positioned to promote air flow over regions to where heat has been moved to dissipate such heat including cooling fan means carried by one or each driven shaft.

In a still further aspect of this disclosure, an exciter apparatus assembly configuration is provided including:
an exciter apparatus having a housing structure, said exciter apparatus being, in use, intended to apply a vibration regime to processing or handling equipment, said housing structure including a plurality of housing fastener zones in a first array; and
a mounting structure separate to said housing structure, said mounting structure having a plurality of mounting structure fastener zones in a second array whereby, in use, said housing fastener zones and said mounting structure fastener zones are alignable enabling connecting fastener means to connect said housing fastener zones to said mounting structure zones.

Preferably, the mounting structure further includes a third array of fastener receiving zones enabling said mounting structure to be mounted operationally to said processing or handling equipment. More preferably, the housing structure has an upper wall and a lower wall, said housing fastener zones including a fastener bore means respectively extending from a first end zone at or adjacent to said upper wall to a second end zone at or adjacent said lower wall.

The first end zone of each said fastener bore means may preferably be located in a single plane. The first end zones may be located above, below or level with an upper surface of the upper wall. The second end zone of each said fastener bore means may preferably be located in a single plane. The second end zones may be located above, below or level with a lower surface of the lower wall.

According to the preceding paragraph, the assembly configuration allows for the possibility of a relatively standard exciter apparatus to be produced for a variety of differing installation designs with the mounting structure being a much simpler part providing the means for adapting the relatively standard exciter apparatus to a variety of different mounting structure designs.

Reference is made in the disclosure of this specification to exciter apparatus, either alone or with other similar devices or equipment being mountable to processing or handling equipment to impose a vibration regime thereto during the use of same. Such processing or handling equipment is primarily intended for use in the mineral processing or handling industries such as mining ore or coal, or quarrying other rock or earth based materials, however, such references are not intended to be limited thereto as the developments disclosed herein are equally applicable to any industry where a vibration regime is required to be imposed.

A number of aspects are disclosed herein in relation to achieving a certain result. It will be recognised by those skilled in the art that a feature disclosed in respect of one aspect may be utilised in any other aspect. Moreover it should also be understood that any terms, if used, such as “comprises”, “comprising”, “includes, “including”, “haves”, and/or “having”, specify the presence of stated features, items, steps, operations, elements, materials and/or components, but do not preclude the presence of, or addition of, one or more other features, items, steps, operations, elements, components, materials and/or groups thereof. The disclosure of this specification should also be regarded as including the subject matter of the claims as annexed.

### BRIEF DESCRIPTION OF THE DRAWINGS

FIG. 1 is a perspective view of a DF6xx series prior art exciter apparatus;

FIG. 2 is a perspective view of the exciter apparatus casing utilised in the exciter apparatus of FIG. 1;

FIG. 3 is a partially exploded perspective view of the exciter apparatus shown in FIG. 1;

FIG. 4 is a transverse horizontal section view through both driven shafts of FIG. 1;

FIG. 5 is a perspective view of a preferred embodiment of exciter apparatus constructed in accordance with the developments of this disclosure;

FIG. 6 is a perspective view similar to FIG. 5 but with the eccentric masses removed from the driven shafts;

FIG. 7 is a perspective view of the exciter apparatus of FIG. 6 taken from the opposite side;

FIG. 8 is a perspective view similar to FIG. 7 but with a side closure plate removed;

FIGS. 9 and 10 are side elevation views similar to FIG. 8 showing potential differing installation positions of the exciter apparatus, from the intermeshing gear side of the exciter apparatus;

FIG. 11 is a perspective view similar to FIG. 1 but with the side closure plates removed revealing bearing means supporting the driven shafts;

FIGS. 12 and 13 are side elevation views similar to FIG. 11 showing potential differing installation positions of the exciter apparatus, from the bearing means side of the exciter apparatus;

FIG. 14 is a perspective view similar to FIGS. 7 and 8 but with the gearing element compartment closure plate and the gearing elements removed with closure plates closing bearing compartments housing bearings supporting the driven shafts;

FIG. 15 is a view similar to FIG. 14 with the bearing compartment closure plates removed showing bearings in the bearing compartments;

FIG. 16 is a perspective view similar to FIG. 6 but with the exciter apparatus casing shown in ghosted outline to reveal aspects of the elongated fastener elements;

FIG. 17 is a horizontally sectioned perspective view through the driven shafts of the exciter apparatus of FIG. 5;

FIG. 18 is a vertical section view of the exciter apparatus passing through the short driven shaft;

FIG. 19 is a section view along line X-X of FIG. 18;

FIG. 20 is a horizontal section in plan view of the exciter apparatus generally through the driven shafts; and

FIG. 21 is a perspective view of an exciter apparatus casing generally as utilised in earlier FIGS. 5 to 17 and 18 to 20.

### DETAILED DESCRIPTION OF PREFERRED EMBODIMENTS

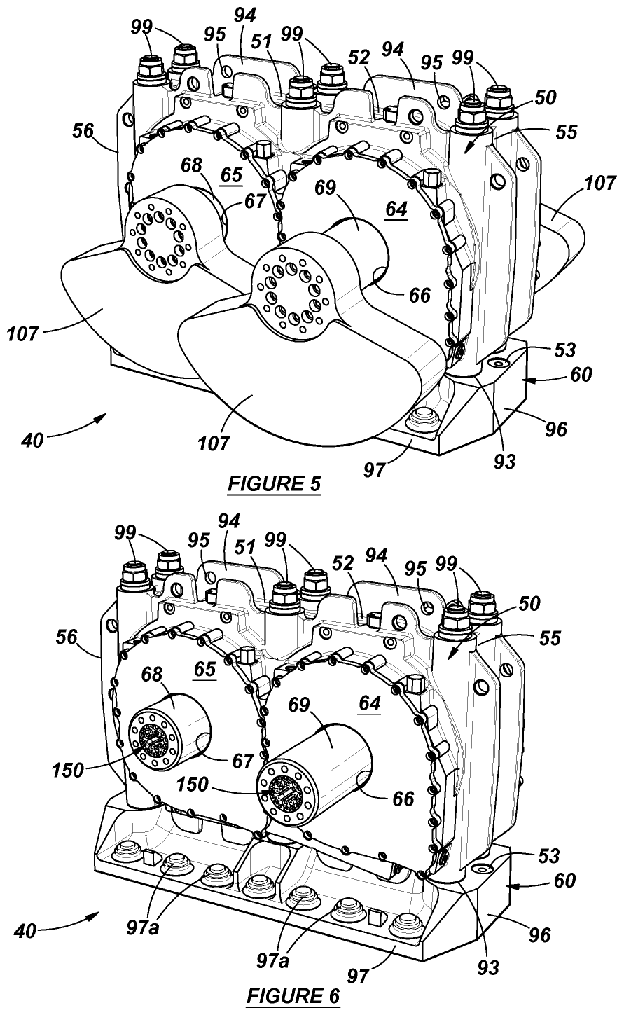

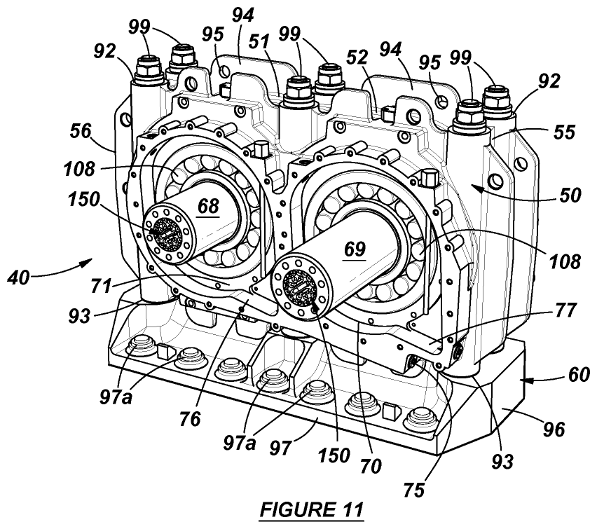

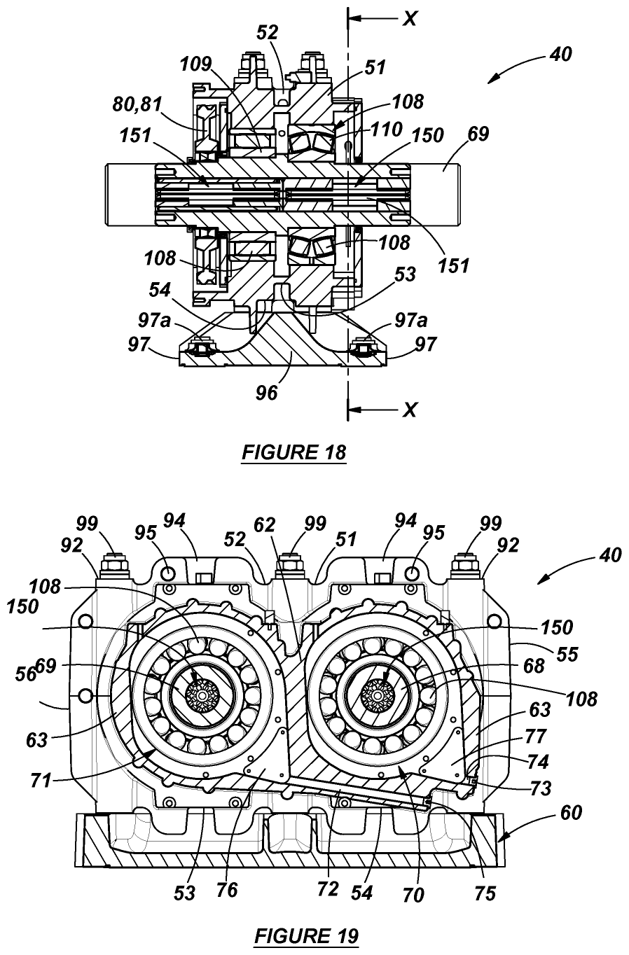

Improvements in exciter apparatus 40 and associated parts such as an exciter apparatus casing 50 and an adapter mounting plate 60 are described in the following. The exciter apparatus casing 50 is shown in many of FIGS. 5 to 17 and 18 to 20 but is represented specifically in FIG. 21 as a single piece, typically constructed as a metallic casting. The exciter apparatus casing 50 has an upper wall 51 with an upwardly facing surface 52, a lower wall 53 with a downwardly facing surface 54, and two opposed end walls 55, 56 continuously formed with the upper wall 51 and the lower wall 53. The exciter apparatus casing 50 further includes a first side face 57 and a second side face 58, facing in opposite directions.

As can be seen in FIG. 21, the exciter apparatus casing 50 has a first bearing mounting compartment 59 adjacent to and inwardly positioned relative to an end wall 55, and a second bearing mounting compartment 61 adjacent to and inwardly positioned relative to the other end wall 56. An intermediate wall structure 62 connected to the upper wall 51 and the lower wall 52 is positioned between the first and second bearing compartments 59, 61. A seal surface 63 is located in the first side face 57 and forms part of the intermediate wall structure 62 and surrounds the first and the second bearing compartments 59, 61. As can be seen in FIGS. 5, 6 and other drawings, closure plate members 64, 65 are mounted to and sealed to the seal surface 63 by a plurality of fastener members of any suitable type. The closure plate members 64, 65 include central openings 66, 67 which accommodate respectively a short driven shaft 68 and a long driven shaft 69 with suitable seals (not shown) engaging with the shafts 68, 69 to maintain sealed conditions within the exciter apparatus 40.

As also can be seen in FIG. 21 an enlarged region forming a first bearing lubricating liquid sump zone 70 is positioned between the first bearing mounting compartment 59 and the closure plate member 64. A similar enlarged region forming a second bearing liquid sump zone 71 is positioned between the second bearing mounting compartment 61 and the closure plate 65. In the assembled configuration of the exciter apparatus 40, the first and the second bearing liquid sump zones 70, 71 are maintained completely separate from one another whereby it is possible to prevent contaminants from the gear liquid sump entering the bearing liquid sumps, also to select and use lubricating liquids in the respective sump zones 70 and 71 that have differing characteristics, such as viscosity, that are best selected for operation of the exciter apparatus 40, particularly to improve performance of same and to extend periods between potential maintenance stages.

FIG. 19 illustrates a drain passage 74 leading from the first bearing liquid lubricant sump zone 70 to a drain point 73 whereby, during a maintenance stage, used liquid lubricant can be removed from the first bearing liquid sump zone 70. Similarly, a drain passage 72 leading from the second bearing liquid lubricant sump zone 71 to a drain point 75 is provided whereby during a maintenance stage, used liquid lubricant can be removed from the second bearing liquid lubricant sump zone 71. Suitable inlet port means are provided through the upper wall 51 to allow original or replacement liquid lubricant to be introduced into either the first or the second bearing liquid lubricant sumps 70, 71. As can be seen in FIG. 21, and other drawings, each of the first and the second bearing liquid lubricant sump zones 70, 71 have a triangular shaped bulge or extension region 76, 77 approaching the entrances to drain passages 72, 74 acting as a collection zone for the liquid lubricant and potentially any particulate debris that might enter or be formed within the exciter apparatus such that it might be removed with any used or spent liquid lubricant.

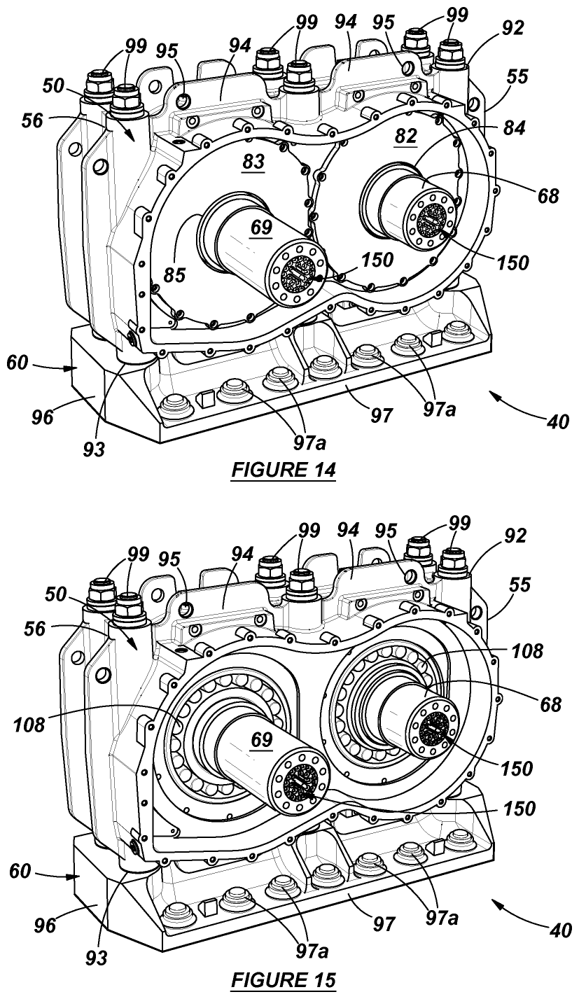

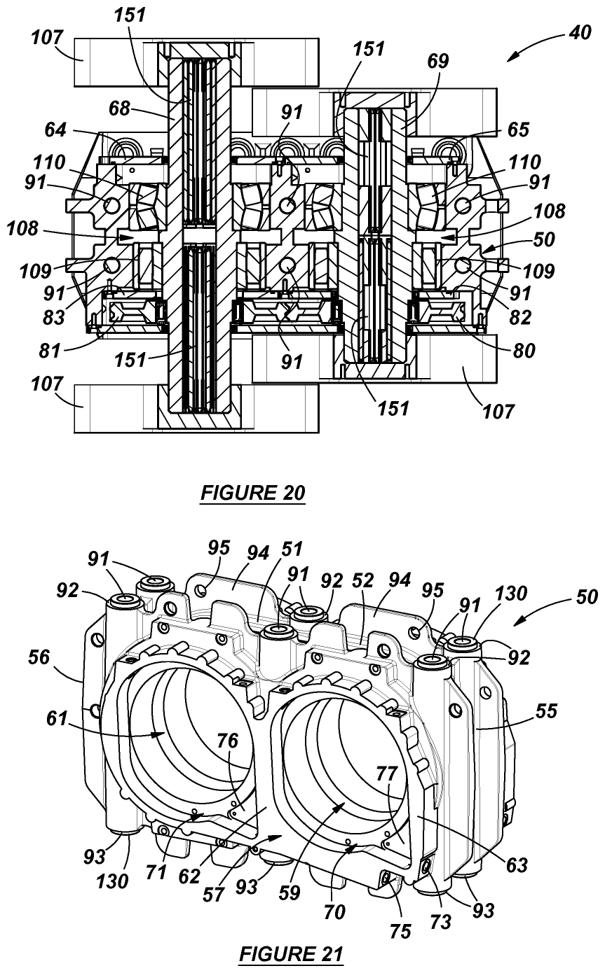

FIGS. 20, 21 illustrate that each of the first and the second bearing mounting compartments 59, 61 end part way towards the second side face 58. The second side face 58 has a seal surface 78 generally surrounding a gearing mounting compartment 79 configured to house separate intermeshing gears 80, 81 that are mounted on the driven shafts 68, 69. Closure plates 82, 83 (FIG. 14) are sealed to the first and second bearing mounting compartments 59, 61 internally of the exciter apparatus 40. The closure plates 82, 83 have central openings 84, 85 through which the driven shafts 68, 69 pass, the closure plates 82, 83 having suitable seal means to prevent liquid lubricant and other materials to pass along the shafts.

As shown, for example, in FIGS. 17, 18 and 20, bearing means 108 may be provided to support the driven shafts 68, 69 in the first and the second bearing mounting compartments 59, 61. The bearing means 108, in each case, may comprise a pair of side by side bearing members 109 and 110. The bearing member 109 is conveniently a toroidal roller bearing and the bearing member 110 is a spherical roller bearing (SRB). While the drawings represent two driven shafts 68, 69 and a consequent supporting bearing arrangement as illustrated, in some embodiments one driven shaft only might be provided and more than two driven shafts might be provided.

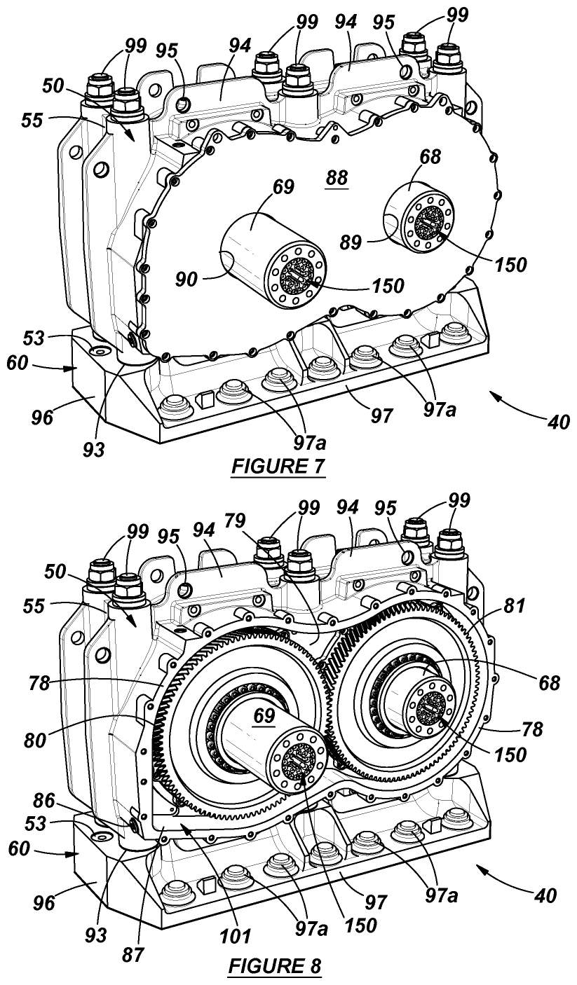

The gearing mounting compartment 79 has a liquid lubricant introduction port in the upper wall 51 whereby liquid lubricant of a desired type or characteristics can be introduced into the compartment 79 either before use or during a later maintenance stage of the exciter apparatus 40. A drain port 86 (FIG. 8) is provided with a communicating drain passage leading to a lower region of the gearing mounting compartment 79. Conveniently, the gearing mounting compartment 79 includes an enlarged triangular bulge portion 87 leading to the drain passage at a low portion of the compartment 79. The compartment 79 provides a gearing lubricating liquid sump zone 101. Conveniently, an outer closure plate 88 closes the gearing mounting compartment 79 by sealing means and multiple fastener members pressing an edge face region of the outer closure plate 88 against the seal surface 78. Again the closure plate 88 includes central openings 89, 90 and seal means cooperating with the driven shafts 68, 69 (FIG. 7).

Referring again to FIG. 21, the exciter apparatus casing 50 incudes a plurality of elongated fastener receiving bore means 91 positioned vertically extending through the casing 50. Each of the fastener receiving bore means 91 includes a first end zone 92 disposed at or adjacent to the upwardly facing surface 52 of the upper wall 51, and a second end zone 93 disposed at or adjacent to the downwardly facing surface 54 of the lower wall 53. Preferably, the fastener receiving bore means 91 includes a continuous bore passage from the first end zone 92 to the second end zone 93. Alternatively, at least some of the fastener receiving bore means 91 include a first bore passage section adjacent the first end zone 92 with a continuous bore passage section aligned with a second bore passage section adjacent the second end zone 93 with a continuous bore passage section. In this latter option, seal means operating between a cooperating elongated fastener and the fastener receiving bore means 91 at the upper level of the exciter apparatus casing 50 and at the lower level of the exciter apparatus housing would be required.

In the illustrated preferred embodiment show in in FIG. 21 and other figures, the fastener receiving bore means 91 are disposed in a defined array, consisting of six bore passages 91, each being adapted to receive an elongated bolt, rod or other suitable fastener 99. Two such bore passages are located on a transverse mid point axis of the exciter apparatus casing 50 and two each are located extending through a respective end wall 55 and 56. In some cases, the two centrally located bore passages might be replaced by a single bore passage centrally located. Other possible arrangements of bore passages in the array are possible, however it is desirable to have the bore passages symmetrically disposed about a central transverse axis. Both of the first end zone 92 and the second end zone 93 may include physical formation means such as the illustrated raised annular ring 130 that is complementary shaped with physical formation means on the adapter mounting plate 60 to prevent or minimise lateral movement when engaged.

If desired the annular ring formations 92a/93a in both the upper wall 51 and the lower wall 52 of the exciter casing 50 may include inclined surfaces to assist movement of the bores 91 into alignment with fastener element engagement regions positioned on the adapter mounting plate 60.

Preferably, both the upper wall 51 and the lower wall 52 includes upstanding flange members 94 with apertures 95 to assist lifting means to be connected to the exciter apparatus 40 when installing or removing such exciter apparatus from an operative position.

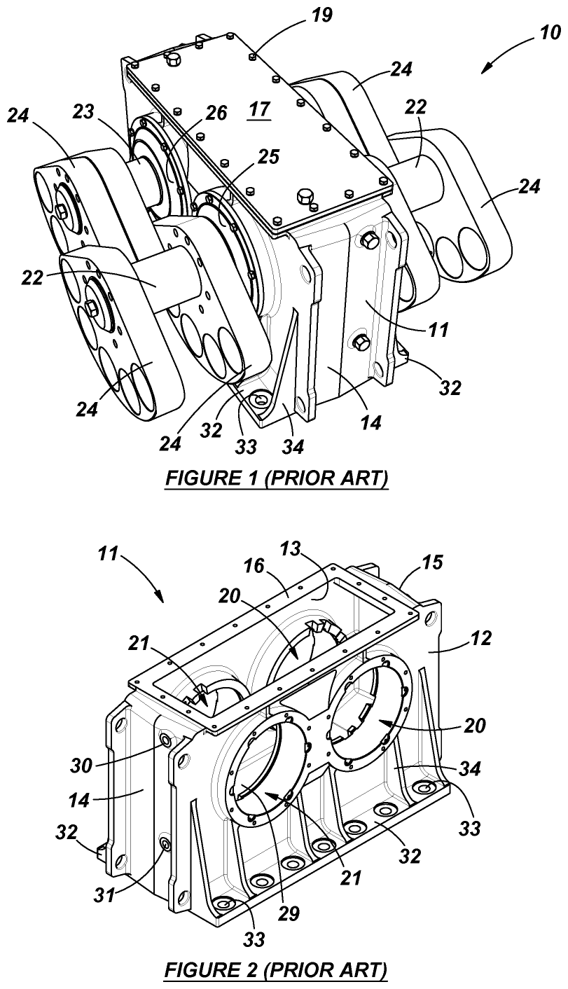

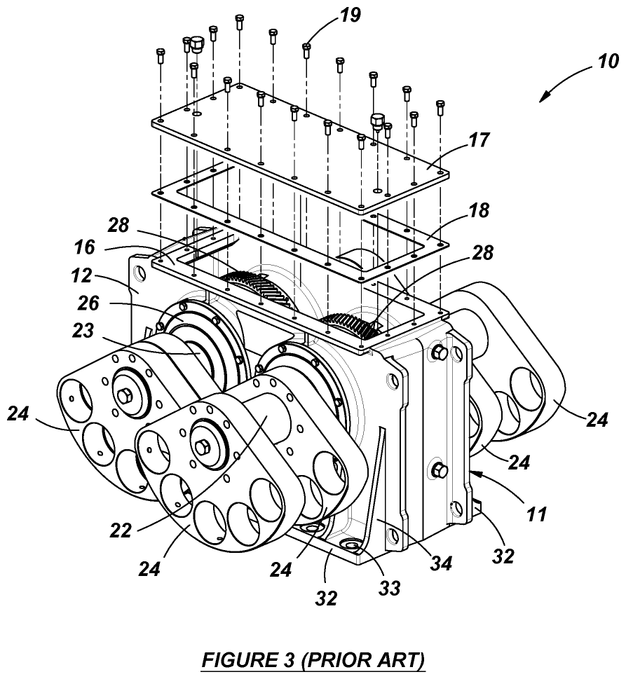

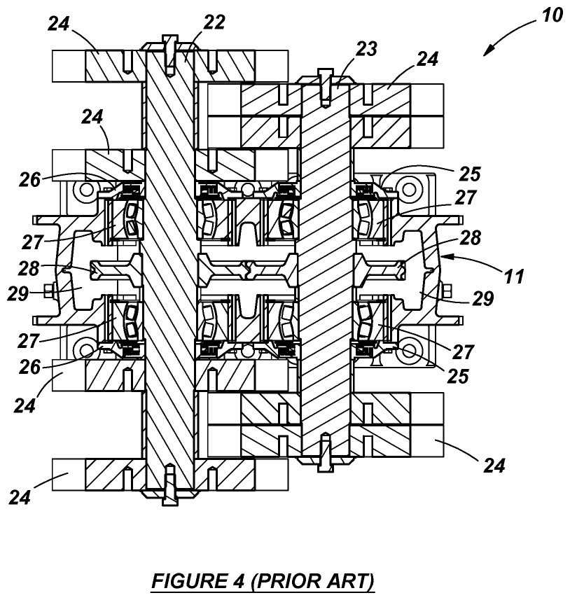

Referring to the drawings, the adapter mounting plate 60 includes a central section 96 and edge sections 97 with spaced bores and fasteners 97a along its length each being adapted to receive a suitable fastener member. In the illustrated embodiments, the bores with fasteners 97a in edge sections 97 are positioned to allow the adapter mounting plate 60 to be mounted to a fixing position in Schenck Process mineral processing or handling equipment constructed to install an existing DF6xx series exciter apparatus, for example, constructed according to FIGS. 1 to 4. In the case of some other existing exciter apparatus that might need to be replaced, the configuration of the adapter mounting plate and the holes or bores for mounting same might vary to be consistent with the existing structures. The adapter mounting plate 60 further includes long bolt or rod fastening positions 98 that may comprise an array of upraised boss formations along the central section 96 configured to correspond and be complementary to the first end zones 92 and the second end zones 93 provided on the upper wall 51 and the lower wall 53 of the exciter apparatus casing 50.

Each of the upraised boss formations include fastening bore means or any other connection means forming the long bolt or rod fastening positions 98 engageable with an end of an elongated fastening bolt, rod or the like 99 passing through an elongated fastener receiving bore means 91. The boss formations may also include formation means cooperable with and complementary to the physical formation means on the first end zone 92 and the second end zone 93 of the fastener receiving bore means 91. Alternatively, the adapter mounting plate 60 may include recessed zones to form the long bolt or rod fastening position 98 engageable with either the first zones 92 or the second end zones 93 of the fastener receiving bore means 91.

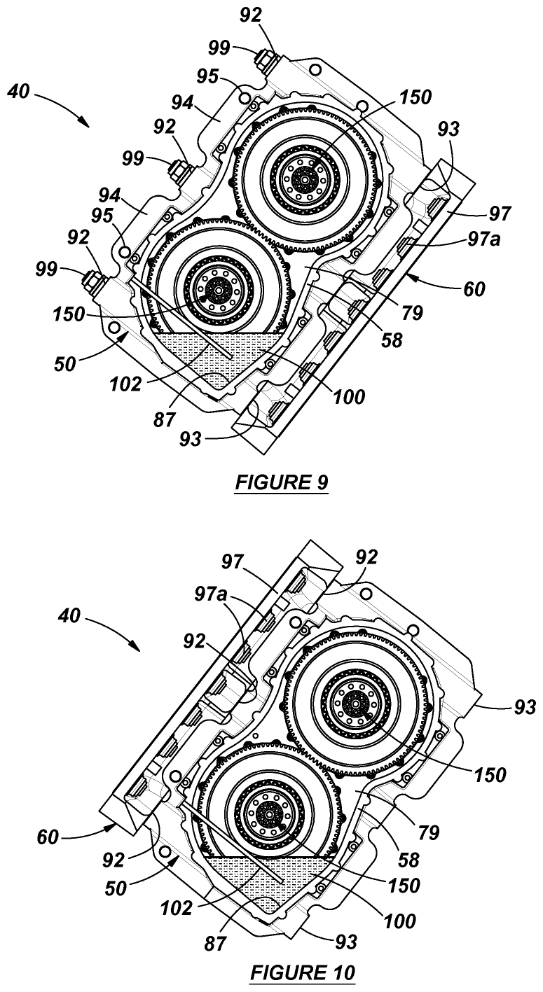

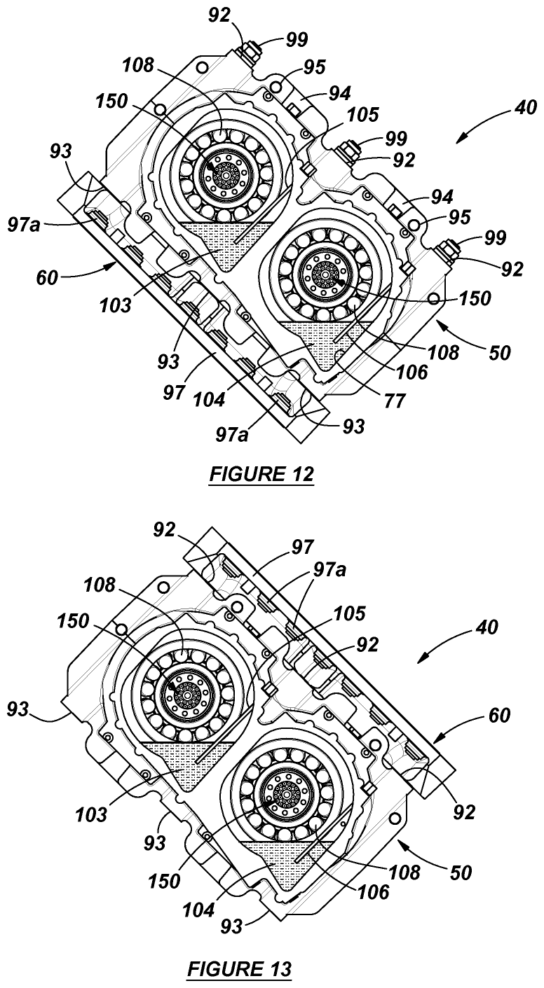

FIGS. 9/10 and FIGS. 12/13 illustrate the effect of mounting the exciter apparatus 40 and the associated adapter mounting plate 60 at differing angles of inclination and particularly when the exciter apparatus is partially inverted as shown in FIGS. 10 and 13. FIGS. 9/10 show the exciter apparatus from the gearing side of the exciter apparatus 40 with the outer closure plate 88 removed. FIGS. 12/13 show the exciter apparatus 40 from the bearing side of the exciter apparatus 40 with the two outer closure plates 64, 65 removed. As shown in FIG. 9, the lower wall 53 of the exciter apparatus casing 50 faces toward the adapter mounting plate 60 with the second end zones 93 of the fastener receiving bore means 91 in engagement with a respective long bolt or rod fastening position 98. In the partially inclined and inverted position shown in FIG. 10 the first end zones 92 of the upper wall 51 are positioned in engagement with a fastening position 98 on the adapter mounting plate 60. In either positional location represented in FIGS. 9 and 10 an elongated fastener member 99 passes through the fastener receiving bore means 91 to secure the exciter apparatus 40 to the adapter mounting plate 60 and thereby to the processing or handling equipment (not shown). FIGS. 9 and 10 illustrate the lubricating liquid pool 100 collected in the gearing lubricating liquid sump zone 101 formed by the compartment 79. The lubricating liquid pool 100 is collected in the region of the enlarged bulge portion 87 and a stationary, semi-permanent, level measuring probe 102 is provided to provide automatically a signal indicative of the liquid level, and thereby, the volume of lubricating liquid in the gearing mounting compartment 79. If the mounting inclination angle is reversed, then the illustrated structures permit the exciter apparatus 40 to be rotated about a central vertical axis such that the lubricating liquid pool 100 will always form in the region of enlarged bulge portion 87 and the level measuring probe 102. In this manner, it is possible to achieve consistent measuring of lubricating liquid volumes in the gearing mounting compartment.

FIGS. 12 and 13 show the effects discussed in the preceding paragraph from the bearing side of the exciter apparatus 40. It is apparent from these drawings that separate lubricating liquid pools 103 and 104 are maintained in the first bearing liquid lubricant sump zone 70 and the second lubricant liquid sump zone 71 with the pools 103, 104 being located in the region of the extension or bulged regions 76, 77. In addition separate liquid level measuring probes 105, 106 are installed in these zones.

FIGS. 9/10 and 12/13 represent the vibration exciter housing 50 mounted in an upwardly extending inclined position (FIGS. 9/12) and an underslung downwardly extending position (FIGS. 10/13). It will of course be appreciated that the angle of inclination of the mounting position could be reversed such that the end wall portions of the exciter housing 50 forming the lowest one of the end wall portions in FIGS. 9/10 and 12/13 would become the higher of the two end wall portions. This would of course be problematic in that the liquid lubricant pools would change position and the liquid lubricant level sensors 102, 105, 106, may not be correctly immersed in the liquid lubricant pools. To avoid this difficultly, the first array of fastener element positioning locations (bores 91) on the upper or lower walls of the exciter housing 50 are positioned whereby the exciter housing 50 can be rotated about a vertical intermediate axis such that the end wall represented as the lower most one in FIGS. 9/10 and 12/13 will always remain the lower most end wall whereby the liquid lubricant pools in the respective sump zones will remain in the same position (as illustrated in FIGS. 9/10 and 12/13). This can be achieved by arranging the fastener receiving bores 91 to be in an array whereby the bores 91 on one side of a central transverse axis is a mirror image of the bores 91 on the other side of the central transverse axis 143 such that regardless of rotating the position of the exciter housing 50, the bores 91 will continue to align with fastener receiving connection zones in the adapter mounting plate 60 or the vibration processing or handling equipment itself. In the illustrated embodiment, three pairs of fastener receiving bores 91 are illustrated with the central pair of fastener receiving bores 91 being positioned on the aforesaid transverse axis 143. Other configurations, are of course, possible.

Generally, the exciter apparatus 40 will carry eccentric masses 107 carried on the driven shafts 68, 69 (FIG. 5). In the proposed design, the one eccentric mass 107 is carried at each end zone of the driven shafts 68, 69 which overlap, in use when the driven shafts 68, 69 are rotated. Dynamic guard shields would also be provided (not illustrated) mounted from the exciter apparatus casing 50, however, because of the design arrangements previously described, access to the elongated fastener means 99 is not obstructed. This enables the dynamic guard shields to remain attached to the exciter apparatus 40 if the exciter apparatus 40 is to be removed for any purpose.

FIGS. 17, 18 and 20 and other drawings illustrate one preferred cooling means 150 for cooling the liquid lubricant in the lubricating liquid pools 103, 104 and the bearing means 108. In this proposal, one or multiple cooling element cartridges 151 are installed in a bore or passage 152 axially extending fully through the or each driven shaft 68/69, or at least from a position underlying each bearing means 108 to a position external of the exciter housing 50. Each cooling element cartridge 151 includes a heat receiving mounting part 153 at one end and a heat dissipating part 154 at an external end. Alternatively, in a one piece assembly, a central heat receiving mounting part 153 might be provided with two opposed heat dissipating parts 154 at distal ends of the assembly. Each of the cooling element cartridges 151 further includes at least one and preferably multiple heat pipes 155 as described previously. A heat flow path is thereby established from the bearing means 108 through a respective driven shaft 68 or 69 to a heat receiving mounting part 153 along the heat pipe or pipes 155 to the heat dissipating mounting part 154 positioned externally of the exciter housing 50. Thus, generated heat can be moved to an external location and dissipated therefrom. The heat dissipation process may be helped by providing fan means mounted on a driven shaft, on each driven shaft, or elsewhere in the vibration apparatus 40.

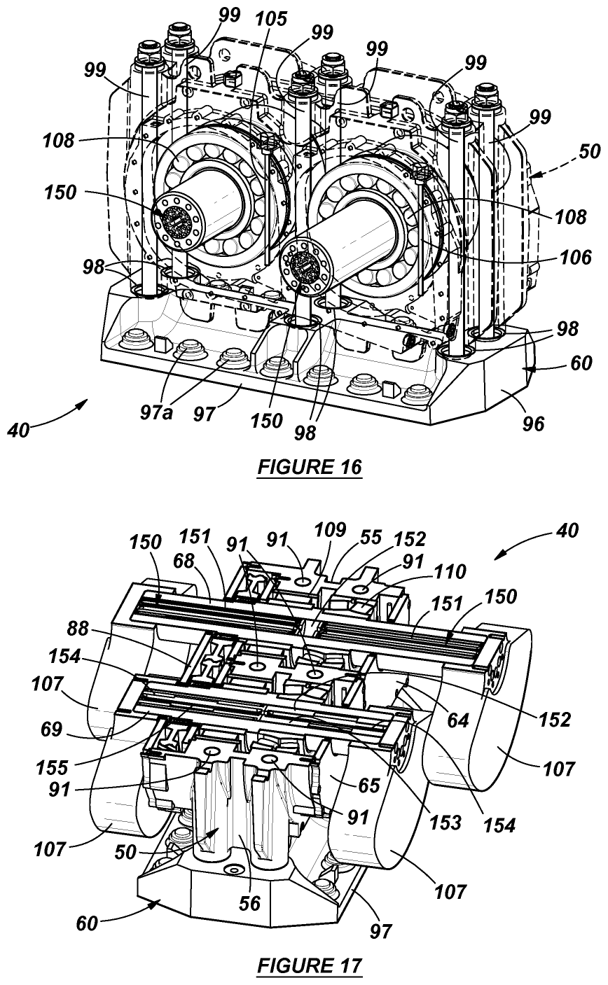

Other possible options might also be used for cooling parts of the exciter apparatus 40, to lower operating temperatures to effectively extend periods of time between maintenance down times. The disclosure proposes, as indicated previously, separate lubricating liquid sump zones with an expectation that these configurations will result in higher heat transfer out of the bearings that occur with current designs. A second option is to utilise high thermal conductivity materials, in the exciter apparatus casing structures, particularly in bearing compartment closure covers. A third potential option is to provide a cooling fan on one or both driven shafts to increase air flow onto the exciter apparatus casing walls. A fourth option is to provide high thermal conductivity inserts into the exciter apparatus walls or the driven shafts. A fifth option is to position heat flow pipes for passage of cooling air flow or liquid flow in the housing walls and the driven shafts. Of course, multiple such options might be utilised. FIGS. 16, 17, 18 and 19 illustrate options for locating heat movement or transfer cartridges 151 in the driven shafts 68, 69.

The foregoing describes various preferred embodiments of exciter apparatus for imposing a vibration regime to mineral processing or handling equipment and to parts of such exciter apparatus. Improvement features, in some instances, also relate to and may be applied to other known exciter apparatus by skilled persons in this art. Features disclosed specifically in relation to one embodiment might equally apply to other exciter apparatus, and parts of same, within the context of the annexed patent claims.

1. A vibration exciter apparatus configured, in use, to impose a vibration regime to vibration processing or handling equipment, said exciter apparatus comprising:
an exciter housing;
first bearing means and second bearing means positioned in said exciter housing, each first and second bearing means supporting a driven shaft carrying eccentric mass means externally of said exciter housing;
a pair of intermeshing gears, each gear being carried by a respective driven shaft for rotation therewith;
a first liquid lubricant sump for a first one of said bearing means located within said exciter housing;
a second liquid lubricant sump for a second one of said bearing means located within said exciter housing, whereby said second liquid lubricant sump is separate from said first liquid lubricant sump; and
a third liquid lubricant sump for said intermeshing gears located within said exciter housing, said third liquid lubricant sump being separate from said first and said second liquid lubricant sumps.

2. The vibration exciter apparatus according to claim 1, wherein, in use, said first bearing means is partially immersed in liquid lubricant located in said first liquid lubricant sump and said second bearing means is partially immersed in liquid lubricant located in said second liquid lubricant sump.

3. The vibration exciter apparatus according to claim 1, wherein, in use, at least one of said intermeshing gears is partially immersed in liquid lubricant in said third liquid lubricant sump.

4. The vibration exciter apparatus according to claim 1, wherein the first bearing means includes at least two bearing members, one said bearing member being a spherical roller bearing and a second bearing members being a toroidal roller bearing member.

5. The vibration exciter apparatus according to claim 1, wherein an interior region of said exciter housing is divided by an intermediary wall portion into two compartment zones, one of said two compartment zones mounting the first bearing means, and a second one of said two compartment zones mounting the second bearing means, each of said two compartment zones being positioned adjacent a first side face of said exciter housing.

6. The vibration exciter apparatus according to claim 5, wherein the interior region of said exciter housing includes a third compartment zone housing said intermeshing gears, said third compartment zone being positioned between said two compartment zones and a second side face of said exciter housing opposite said first side face of said exciter housing.

7. The vibration exciter apparatus according to claim 5, or wherein said exciter housing includes an exciter casing with an upper wall, a lower wall, and two opposed end walls connected to said upper and said lower walls, at least said second side face of said exciter casing is substantially open being closable by a first side wall securable to the upper wall, the lower wall and said end walls by a plurality of first fastener elements.

8. The vibration exciter apparatus according to claim 7, wherein the first side face of said exciter casing is substantially open and is closable by a second side wall securable to the upper wall, the lower wall and said end walls by a plurality of second fastener elements.

9. The vibration exciter apparatus according to claim 7, wherein said exciter casing has an intermediary open region between said two compartment zones and said third compartment zone, an intermediary dividing wall being securable to said exciter casing to separate said third compartment zone from said two compartment zones.

10. The vibration exciter apparatus according to claim 1, wherein first inlet means is provided allowing liquid lubricant to be introduced into said first liquid lubricant sump.

11. The vibration exciter apparatus according to claim 10, further comprising first drain means allowing liquid lubricant to be withdrawn from said first liquid lubricant sump.

12. The vibration exciter apparatus according to claim 11, further comprising an enlarged particulate debris collection zone in said first liquid lubricant sump immediately adjacent said first drain means.

13. The vibration exciter apparatus according to claim 10, further comprising a liquid lubricant level indicating sensor positioned to sense and report liquid lubricant level in said first liquid lubricant sump.

14. The vibration exciter apparatus according to claim 1, wherein second inlet means is provided allowing liquid lubricant to be introduced into said second liquid lubricant sump.

15. The vibration exciter apparatus according to claim 14, further comprising a second drain means allowing liquid lubricant to be withdrawn from said second liquid lubricant sump.

16. The vibration exciter apparatus according to claim 15, further comprising an enlarged particulate debris collection zone in said second liquid lubricant sump immediately adjacent said second drain means.

17. The vibration exciter apparatus according to claim 14, further comprising a liquid lubricant level indicating sensor positioned to sense and report a liquid lubricant level in said second liquid lubricant sump.

18. The vibration exciter apparatus according to claim 1, wherein third inlet means is provided allowing liquid lubricant to be introduced into said third liquid lubricant sump.

19. The vibration exciter apparatus according to claim 18, further comprising a third drain means allowing liquid lubricant to be withdrawn from said third liquid lubricant sump.

20. The vibration exciter apparatus according to claim 19, further comprising an enlarged particulate debris collection zone in said third liquid lubricant sump immediately adjacent said third drain means.

21. The vibration exciter apparatus according to claim 18, further comprising a liquid lubricant level indicating sensor positioned to sense and report liquid lubricant level in said third liquid lubricant sump.

22. The vibration exciter apparatus according to claim 7, wherein said exciter housing includes at least one fastener receivable passage means extending from said upper wall to said lower wall through at least each said end wall, and through an intermediary part of said exciter housing between said first and second liquid lubricant sumps.

23. The vibration exciter apparatus according to claim 22, wherein either said upper wall or said lower wall is positioned closer to said vibration processing or handling equipment when said vibration exciter apparatus is mounted thereto.

24. A vibration exciter apparatus casing for use in vibration exciter apparatus intended, in use, to impose a vibration regime to vibration processing or handling equipment, said vibration exciter apparatus casing comprising a substantially continuous wall structure with an upper wall portion, an opposed lower wall portion, two mutually spaced and opposed end wall portions, and two mutually spaced side faces together defining an internal zone, said internal zone including two bearing mounting compartments separated by a transversely disposed intermediate wall structure extending from a first said side face, each said bearing mounting compartment including a bearing lubricating liquid sump zone separate from the other said bearing mounting compartment, said transversely disposed intermediate wall structure and said bearing mounting compartments being spaced from a second said side face opposed to said first side face whereby a gearing mounting compartment and an associated gearing lubricating liquid sump zone are positioned adjacent said second side face.

25. The vibration exciter apparatus casing according to claim 24, wherein at least one fastener receivable bore passage passes through each said end wall portion and said intermediate wall structure from said upper wall portion to said lower wall portion.

26. The vibration exciter apparatus according to claim 25, wherein at least two fastener receivable bore passages are provided through each said end wall portion.

27. The vibration exciter apparatus according to claim 26, wherein the at least two fastener receivable bore passages are provided through said intermediate wall passage.
